(19) United States
(12) Patent Application Publication
(10) Pub. No.: US 2008/0014396 A1
(43) Pub. Date: Jan. 17, 2008

(54) Welding method for plastic joint, and junction part structure of plastic joint

(76) Inventors: Hisaji Nakagawa, Kanagawa (JP); Fumiko Nakagawa, Kanagawa (JP); Yurika Nakagawa, Kanagawa (JP); Rie Nakagawa, Kanagawa (JP)

Correspondence Address: TAKEUCHI & KUBOTERA, LLP, SUITE 202, 200 DAINGERFIELD ROAD, ALEXANDRIA, VA, 22314, US

(21) Appl. No.: 11/783,105

(22) Filed: Apr. 5, 2007

(30) Foreign Application Priority Data
Apr. 7, 2006 (JP) 2006-105783

(51) Int. Cl. B29D 23/00

(52) U.S. Cl. 428/36.9; 425/174.4

(57) ABSTRACT

A welding method for plastic joint that will not cause a residence of the fluid and an increase in pressure loss of the fluid flow due to a bead on the inner wall in a junction part of a welded plastic joint is provided. The welding method for plastic joint (10) is a method for heat welding of a junction part (30) including the jointing faces (12, 21) which are the respective end faces of a heat weldable plastic joint (10) and a plastic tube member (20) which is heat weldable as well, being butted against each other, wherein the plastic joint (10) and the plastic tube member (20) are disposed such that the outer peripheral surface (10a) in the portion including at least jointing faces (12, 21) in the junction part (30) is exposed; a heat source (60) for welding is disposed, being spaced apart from the junction part (30); and with the radiant heat from the heat source (60), the junction part (30) is heated for welding.

### BACKGROUND OF THE INVENTION AND RELATED ART STATEMENT

The present invention relates to a method of welding a plastic joint, in which a junction part is heated for welding. The junction part includes jointing faces which are respective end faces of a heat weldable plastic joint and a plastic tube member which is heat weldable as well, being butted against each other. The present invention also relates to a junction part structure of a plastic joint.

Conventionally, as a method of welding a plastic joint and a plastic tube member to each other with heat, various welding methods, such as spigot welding, butt welding, and the like, have been available. In the welding methods, a junction part, in which end faces of the plastic joint and the plastic tube member are butted against each other, is heated for welding. In heating, an inner wall surface of a heat resistant fixing member is butted against an outer peripheral surface in the junction part. A heat source of a welding apparatus is disposed such that it surrounds the fixing member. The fixing member fixes the junction part, and transfers heat from the heat source in the welding apparatus to the junction part.

As the junction part is heated with the components being thus disposed, both the plastic joint and the plastic tube member are fused to integrally form the junction part. In this case, the fixing member is butted against the outer peripheral surface in the junction part, thus a resin fused by heat does not flow out to the outer peripheral surface in the junction part, and the outer peripheral surface does not be bulged. However, nothing is butted against the inner peripheral surface in the junction part. Accordingly, the resin thus fused may flow out to the inner peripheral surface, thereby forming a bead.

When the bead is formed inside the plastic tube member, the bead may prevent fluid inside the plastic tube member from smoothly flowing. In addition, the bead may present a problem of increasing pressure loss for the fluid flow.

As a method of welding a plastic joint and a plastic tube member to each other while preventing such a bead, there has been provided a method, in which a core element is inserted for contacting with an inner peripheral surface in a junction part before heating (refer to Japanese Patent Publication No. 05-104632). Further, there has been provided a method, in which a bladder is inserted as a device for supporting an inner peripheral surface before heating (refer to Japanese Patent Publication No. 01-110127). In the methods thus provided, the core element or the bladder may suppress a bead from bulging to the inner peripheral surface in the junction part.

In the conventional methods, the core element or the bladder is inserted into the junction part. Accordingly, the number of processes for welding is increased. In addition, a member, such as the core element or the bladder, is required, thereby increasing cost due to the member.

In view of such a problem, an object of the present invention is to provide a method of welding a plastic joint and a joint structure of a plastic joint without preventing fluid from smoothly flowing or increasing pressure loss of fluid flow due to a bead formed on an inner wall in a junction part of the plastic joint.

### SUMMARY OF THE INVENTION

In order to achieve the above objects, according to a first aspect of the present invention, there is provided a method of welding a plastic joint, in which a junction part is heated for welding. The junction part includes jointing faces which are respective end faces of a heat weldable plastic joint and a plastic tube member which is heat weldable as well, being butted against each other. The method includes: arranging the plastic joint and the plastic tube member such that an outer peripheral surface in a portion including at least the jointing faces in the junction part is exposed; arranging a heat source at a location away from the junction part; and heating and welding the junction part with radiant heat of the heat source.

According to a second aspect of the present invention, in the method of welding a plastic joint according to the first aspect, the part of the junction part is fixed with a fixing member such that the outer peripheral surface in the portion including at least the jointing faces in the junction part is exposed.

According to a third aspect of the present invention, in the method of welding a plastic joint according to the second aspect, wherein the fixing member covers and fixes the portion of the junction part.

According to a fourth aspect of the present invention, in the method of welding a plastic joint according to the first aspect, the part of the junction part is fixed with a fixing member built in a clamp for fixing the plastic joint and the plastic tube member such that the outer peripheral surface in the portion including at least the jointing faces in the junction part is exposed.

According to a fifth aspect of the present invention, a junction part structure of a plastic joint is to be welded by heating a junction part. The junction part includes jointing faces of end faces of the plastic joint with heat weldability and a plastic tube member with heat weldability contacting with each other. The junction part has gentle bulges on an outer peripheral surface and an inner peripheral surface.

According to a sixth aspect of the present invention, in the junction part structure of a plastic joint according to the fifth aspect, the bulges of the junction part have a degree of transparency higher than that of other portion.

According to a seventh aspect of the present invention, in the junction part structure of a plastic joint according to fifth aspect, the plastic tube member is another plastic joint.

According to the present invention, it is possible to obtain the following functions.

In order to connect between a heat weldable plastic joint and a plastic tube member which is heat weldable as well such that they are communicated with each other, the junction part including the jointing faces which are the respective end faces butted against each other is heated from the outside to be fused for welding. A diameter of the inner peripheral surface in the end part of the plastic joint that has the end face to be butted is made slightly larger than an outside diameter of the plastic tube member, ranging from the end face of the plastic joint at a mouth thereof inward to a prescribed location. Into the portion having a larger diameter, the end part of the plastic tube member is inserted to cause the end faces to be butted against each other.

In the junction part, to the end face of the plastic joint at the mouth thereof, a heat resistant fixing member for fixing one portion of the junction part is mounted such that the outer peripheral surface in the portion including at least the jointing faces is exposed. Thereby, the plastic joint and the plastic tube member can positively maintain the jointed state. The plastic joint and the plastic tube member which are thus fixed are disposed in a prescribed location in the welding apparatus.

The welding apparatus comprises a heat source for heating the junction part, and a clamp for holding down the plastic joint and the plastic tube member. The plastic joint and the plastic tube member which are disposed in a prescribed position are held down with the clamp before being heated.

The heat source for heating the junction part is disposed, being spaced apart from the junction part and the fixing member, thus heating of the junction part is carried out with the radiant heat from the heat source.

When the junction part is subjected to the radiant heat, resulting in the temperature being raised, the plastic joint and the plastic tube member are fused and expanded. At this time, the junction part is covered with the fixing member in one portion, so that the junction part can partially expand toward the outside from the outer peripheral surface. Thus, the degree of expansion on the side of the inner peripheral surface is reduced by the amount of expansion toward the outside. In addition, the junction part can bulge over a wide range, resulting in the bulge being rendered gentle on both sides of the outer peripheral surface and the inner peripheral surface. The plastic joint and the plastic tube member thus fused form an integrally welded part.

With the plastic joint and the plastic tube member thus welded, even if a bead is produced on the inner peripheral surface in the junction part, the bead is so gentle and the bulge thereof is so small that the finished product is free from residence of fluid flowing therein, increase in pressure loss of the flow, and other possible ill effects.

Further, the outer peripheral surface in the junction part is exposed almost over the entire portion, and no component is contacted therewith in heat welding, resulting in a smooth and neat outer peripheral surface.

In a case where the plastic joint and the plastic tube member which are made of PFA are to be welded, the portion fused by heating is rendered more transparent. Accordingly, through visual examination of an increased degree of transparency, the degree of welding can be determined.

In addition, the plastic tube member to be welded to the plastic joint may be a heat weldable plastic joint. Thereby, a complicated plastic joint can be manufactured.

Further, when the fixing member is built in the clamp, and is made of a non-stick material relative to the plastic joint and the plastic tube member such as glass, ceramic, and the like, it is not necessary to mount the fixing member on the end face of the plastic joint.

### BRIEF DESCRIPTION OF THE DRAWINGS

FIG. 1 is a longitudinal sectional view illustrating a connected state between a plastic joint and a plastic tube member welded to each other by a welding method according to an embodiment of the present invention;

FIG. 2 is a drawing illustrating an arrangement of the plastic joint, the plastic tube member, and a heat source viewed from a direction of arrow A in FIG. 1;

FIG. 3(A) to FIG. 3(C) are drawings illustrating the plastic joint according to one embodiment of the present invention, wherein FIG. 3(A) is a drawing viewed from a tube end part to be welded, FIG. 3(B) is a longitudinal sectional view, and FIG. 3(C) is a sectional view taken along a line 3(C)-3(C) in FIG. 3(B);

FIG. 4(A) to FIG. 4(C) are drawings illustrating a fixing member as shown in FIG. 1, wherein FIG. 4(A) is a front view thereof, FIG. 4(B) is a longitudinal sectional view thereof, and FIG. 4(C) is a rear view thereof;

FIG. 5(A) and FIG. 5(B) are drawings illustrating the plastic joint as shown in FIG. 3 and the fixing member shown in FIG. 4, wherein FIG. 5(A) is an explanation drawing illustrating a method of fitting the fixing member to the plastic joint, and FIG. 5(B) is a longitudinal sectional view illustrating a state in which the fixing member is fitted to the plastic joint;

FIG. 6 is an explanation drawing illustrating a method of inserting the plastic tube member into the plastic joint to which the fixing member is fitted as shown in FIG. 5(B);

FIG. 7 is a longitudinal sectional view illustrating a state in which the plastic tube member is inserted into the plastic joint to which the fixing member is fitted;

FIG. 8 is an explanation drawing illustrating a positional relationship between a heat source in heat welding, and the plastic joint and the plastic tube member shown in FIG. 7;

FIG. 9 is a longitudinal sectional view illustrating a state of the plastic joint and the plastic tube member shown in FIG. 8 during heat welding;

FIG. 10 is a longitudinal sectional view illustrating a state of the plastic joint and the plastic tube member shown in FIG. 8 when the heat welding is completed; and

FIG. 11 is a longitudinal sectional view illustrating a connected state between the plastic joint and the plastic tube member in a case where the fixing member is built in a welding apparatus.

### DETAILED DESCRIPTION OF THE PREFERRED EMBODIMENTS

Hereinbelow, embodiments of the present invention will be described with reference to the accompanying drawings.

The respective drawings show an embodiment of the present invention.

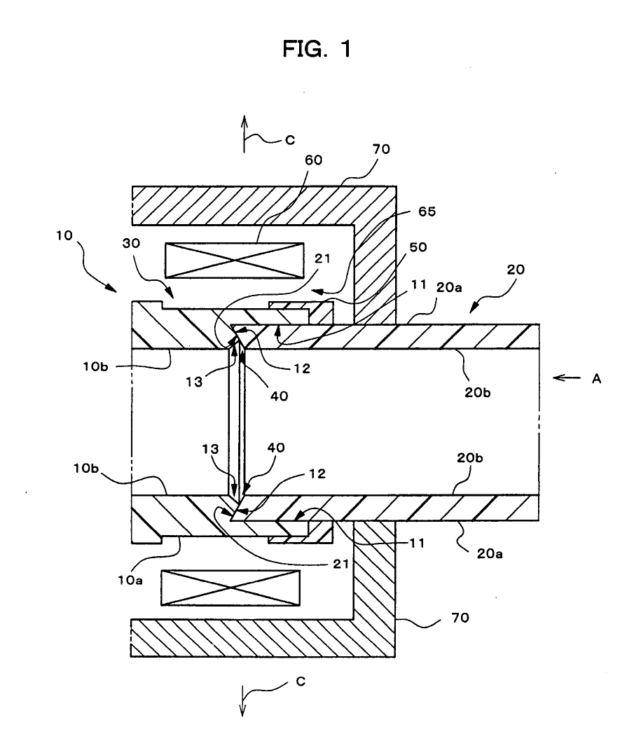

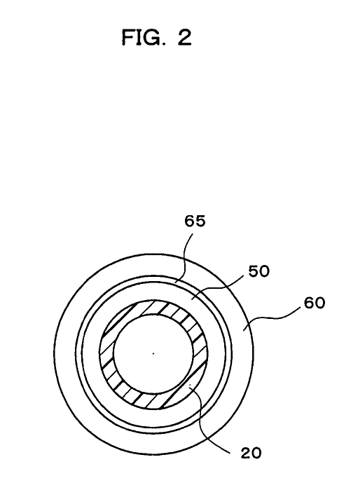

FIG. 1 is a longitudinal sectional view illustrating the connected state between a plastic joint and a plastic tube member when they are welded to each other by the welding method pertaining to one embodiment of the present invention. FIG. 2 is a drawing illustrating the arrangement of the plastic joint, the plastic tube member, and the heat source when viewed from the direction of arrow A of FIG. 1.

The plastic joint 10 and the plastic tube member 20 are formed of a heat weldable material. Examples of the heat weldable material include fluorocarbon resins, such as per-fluoroalkylvinylether-tetrafluoro-ethylene copolymer (PFA), and the like.

The plastic joint 10 as exemplified in FIG. 1 is a straight joint, however, it may be an elbow joint, which is bent in the shape of a letter L, or a T-joint, which is branched in the shape of a letter T. The plastic tube member 20 is, for example, a tubular plastic tube.

These plastic joint 10 and the plastic tube member 20 are formed such that the end faces in the tube end parts to be welded to each other are contacted with each other to provide the following jointing faces 12, 21. A junction part 30 including these jointing faces 12, 21 is heated in welding.

In welding, the tube end part of the plastic tube member 20 is inserted into the tube end part of the plastic joint 10. With the plastic tube member 20, the end face of the tube end part to be inserted into the plastic joint 10 is inclined from the outer peripheral surface 20a toward the inner peripheral surface 20b for forming an innerly directed face 21 (a jointing face) which is to be butted against a part of the end face of the plastic joint 10.

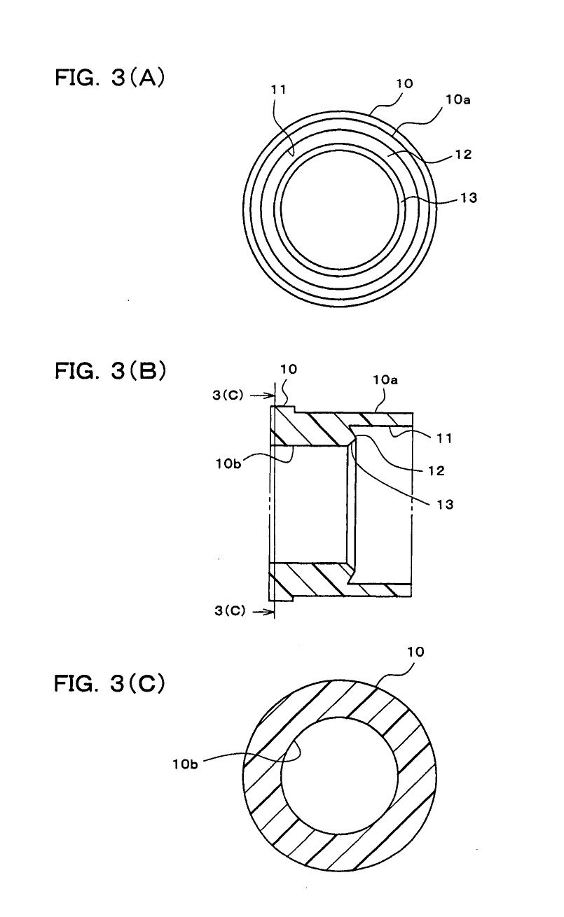

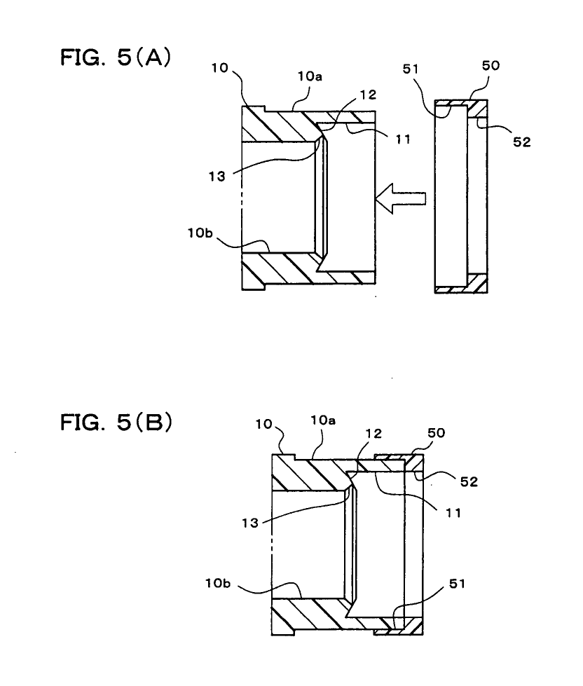

On the other hand, as shown in FIG. 3(A) to FIG. 3(C), FIG. 5(A), and FIG. 5(B) to FIG. 8, in the plastic joint 10, a contact surface 11 which provides an inside diameter slightly larger than the outside diameter of the plastic tube member 20 is formed from the mouth of the tube end part receiving the plastic tube member 20 toward the inside thereof. The plastic tube member 20 can be inserted such that the outer peripheral surface 20a is in contact with the contact surface 11. From the point where this contact surface 11 is ended, an outerly directed face 12 (a jointing face) is formed such that it is to be butted against the innerly directed face 21 of the plastic tube member 20, being surface-contacted. This outerly directed face 12 does not reach the inner peripheral surface 10b of the plastic joint 10, and from the end thereof to the inner peripheral surface 10b, an innerly directed face 13 which is directed toward the rear of the plastic joint 10 is formed. In addition, the outer peripheral surface 10a of the plastic joint 10 is formed such that the outside diameter is decreased in the tube end part. This is a geometry which is for accommodating the expansion of the inner peripheral surface 10b toward the outside in heat welding, as described later.

The part of the innerly directed face 21 of the plastic tube member 20 that is not in contact with the plastic joint 10 and the innerly directed face 13 form a recess part 40. This recess part 40 is a portion where, when the junction part 30 is heated, a part of the molten material is collected. This recess part 40 allows the degree of bulging of the molten material toward the inner peripheral surface 10b, 20b to be reduced.

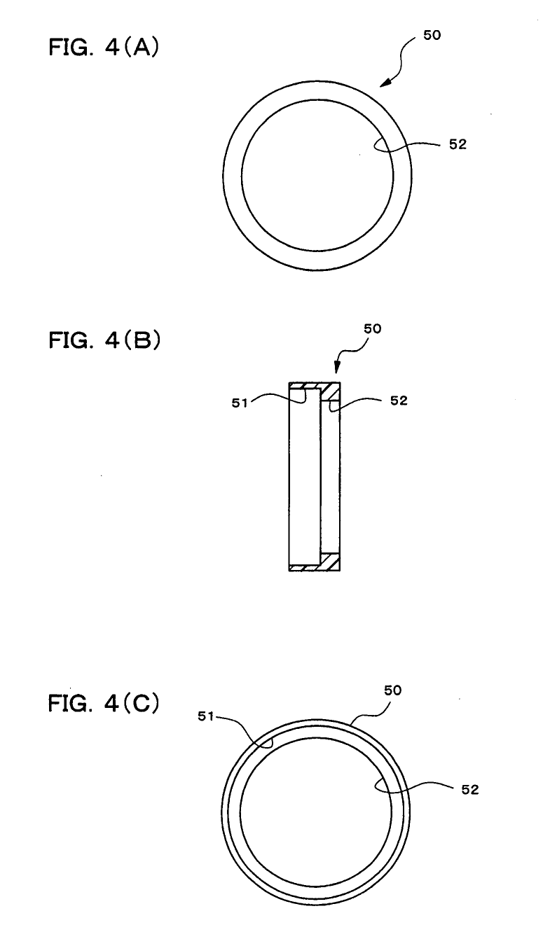

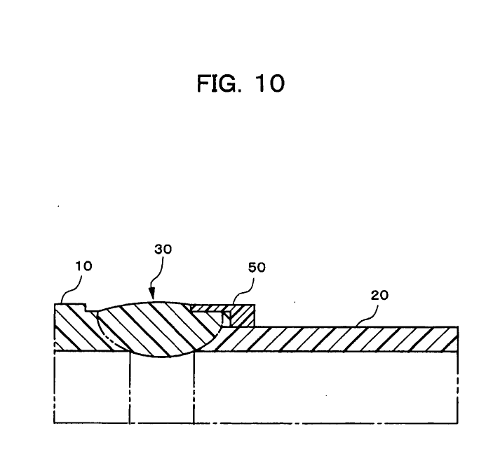

In the junction part 30, a heat resistant fixing member 50 is mounted to the end face of the plastic joint 10 at the mouth thereof. As shown in FIG. 4(A), FIG. 4(B) and FIG. 4(C) to FIG. 10, the fixing member 50 is a tubular member having an inner wall part 51 on the joint side that has an inside diameter slightly larger than the outside diameter of the tube end part of the plastic joint 10, and an inner wall part 52 on the tube material side that has an inside diameter smaller than the inside diameter of the inner wall part 51 on the joint side, and slightly larger than the outside diameter of the tube end part of the plastic tube member 20.

This fixing member 50 is used in welding the plastic joint 10 and the plastic tube member 20 to each other for fixing the plastic joint 10 and the plastic tube member 20 by outside fitting the inner wall part 51 on the joint side to the tube end part of the plastic joint 10 in the junction part 30, and from the inner wall part 52 on the tube material side, inserting the tube end part of the plastic tube member 20. The diameter of the inner wall part 52 on the tube material side is the same as or substantially the same as the diameter of the contact surface 11 of the plastic joint 10, thus when the fixing member 50 is outside-fitted to the plastic joint 10, the inner wall part 52 on the tube material side and the contact surface 11 can provide surfaces which are smoothly connected to each other.

The fixing member 50 has an overall length which is short to such a degree that, when the plastic joint 10 and the plastic tube member 20 are heat-welded, the outer peripheral surface 10a in the portion including at least the jointing faces 12, 21 is exposed, and the jointed state between the plastic joint 10 and the plastic tube member 20 can be positively maintained. This fixing member 50 is made of, for example, polytetrafluoroethylene (PTFE). In addition, the fixing member 50 may be made of heat-resistant glass, ceramic, or the like, to allow it to be removed after the welding of the plastic joint 10 and the plastic tube member 20 to each other being completed.

The welding apparatus which heats the junction part 30 for welding comprises a heat source 60, and a clamp 70 which holds down the plastic joint 10 and the plastic tube member 20 during heating. The clamp 70 is divided into two segments, and is supported such that it can be rocked from the closed position (the position as shown in FIG. 1) for holding down the plastic joint 10 and the plastic tube member 20, to the open position which is reached when the clamp 70 is operated from the closed position toward the direction of arrow C. The heat source 60 is also divided into two segments, which are disposed in either of the halves of the clamp 70, respectively. When the junction part 30 of the plastic joint 10 and the plastic tube member 20 is disposed in a prescribed location in the welding apparatus, this heat source 60 is spaced apart from the junction part 30 by a prescribed clearance 65, and disposed so as to surround the junction part 30. Therefore, the heating of the junction part 30 and the fixing member 50 is carried out with the radiant heat from the heat source 60, unlike the heating as with the prior art, which causes the heat source 60 to be directly contacted with the fixing member 50, and the like.

Next, the function will be described.

When the plastic joint 10 and the plastic tube member 20 are to be welded to each other, the inner wall part 51 on the joint side of the fixing member 50 is outside-fitted to the tube end part of the plastic joint 10 as shown in FIG. 5(A) and FIG. 5(B).

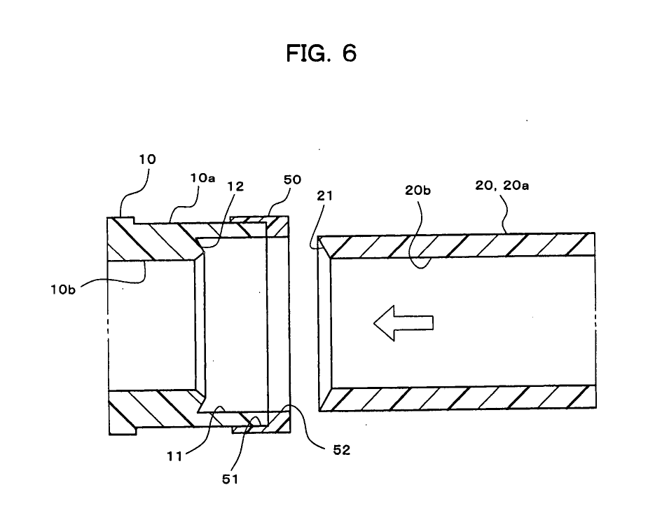

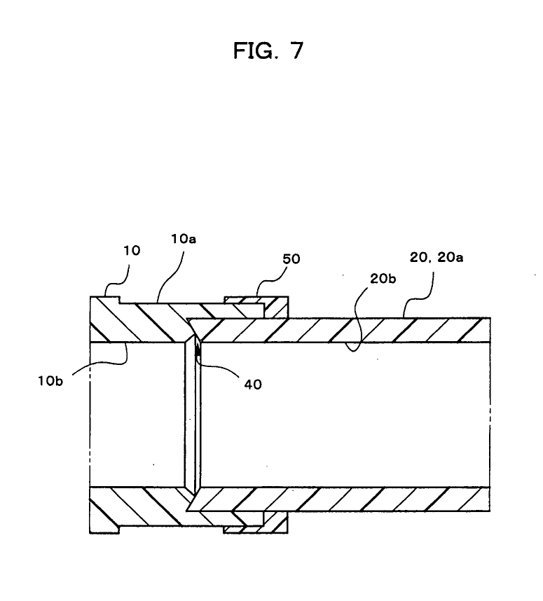

Next, as shown in FIG. 6, from the inner wall part 52 on the tube material side of the fixing member 50, the tube end part of the plastic tube member 20 is inserted. When the plastic tube member 20 is inserted until it is restricted, the innerly directed face 21 constituting the end face of the plastic tube member 20 is butted against the outerly directed face 12 constituting the end face to be butted of the plastic joint 10 as shown in FIG. 7. Only a part of the junction part 30 is covered with the fixing member 50, and the outer peripheral surface 10a in the portion including the jointing faces 12, 21 is exposed.

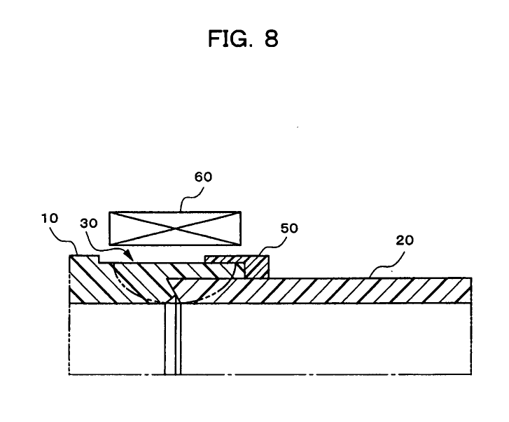

Next, with the clamp 70 of the welding apparatus being kept in the open position, the junction part 30 is set in a prescribed location of the welding apparatus before the clamp 70 being brought into the closed position. At this time, as shown in FIG. 1 and FIG. 8, the junction part 30 is non-contact with the heat source 60, and the entire outer peripheral surface 10a is surrounded by the heat source 60. In this state, heating with the radiant heat from the heat source 60 is started.

When the temperature of the junction part 30 and the fixing member 50 is raised, being subjected to the radiant heat, in case where the fixing member 50 is made of a heat resistant material, such as PTFE, or the like, the junction part 30 is welded to a part of the fixing member 50, or the fixing member 50 is slightly expanded, but the fixing member 50 will not be fused. On the other hand, the junction part 30 constituted by the plastic joint 10 and the plastic tube member 20 will be fused and expanded.

Such bulge due to the expansion is caused in both the outward direction from the outer peripheral surface 10a and the inward direction from the inner peripheral surface 10b, 20b in the junction part 30. Therefore, the expansion is distributed in two directions, thus the degree of bulge is reduced in any of the outer peripheral surface 10a and the inner peripheral surface 10b, 20b.

In addition, bulge is caused over a wide range which is exposed to the heat source 60, thus the bulge is rendered gentle on both sides of the outer peripheral surface 10a and the inner peripheral surface 10b, 20b, which further reduces the degree of bulge. Especially, on the side of the inner peripheral surface 10b, 20b, the recess part 40 is provided, resulting in the bulge being accommodated to a certain degree, which still further reduces the degree of bulge on the side of the inner peripheral surface 10b, 20b.

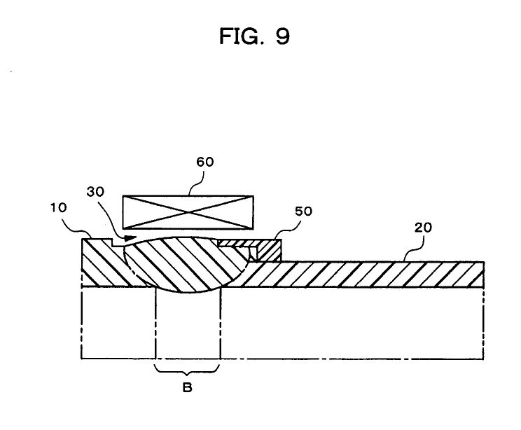

In addition, the breadth of the portion as indicated with a sign B in FIG. 9 accommodates variations in heating, thus the junction part 30 is uniformly welded.

The plastic joint 10 and the plastic tube member 20 which welding has been completed can be removed from the welding apparatus by opening the clamp 70 in the direction of arrow C to bring it to the open position. Even if the plastic joint 10 and the plastic tube member 20 have had a bead produced on the inner peripheral surface 10b, 20b in the junction part 30, the bead is gentle, the degree of bulge being small, thus the fluid flowing inside is prevented from having a residence or an increased loss of pressure, or being otherwise subjected to an ill effect.

As previously described, the heat source 60 is spaced apart from the junction part 30 and the fixing member 50, thus it is non-contact with these during the heat welding, and before and after the heat welding, which results in the outer peripheral surface 10a in the junction part 30 and the surface of the fixing member 50 being smooth and neat.

In addition, in case where the plastic joint 10 and the plastic tube member 20 are both made of PFT, the portion in the junction part 30 that has been fused by the heating is rendered transparent, thus by visually examining the degree of transparency, the degree of welding can be determined.

In the above description, the plastic tube member 20 to be welded to the plastic joint 10 has been adapted to be a heat weldable plastic tube, but the plastic tube may be replaced with a heat weldable plastic joint 10. In other words, the plastic joints may be welded to each other. Thereby, a plastic joint 10 having a complicated geometry can be manufactured.

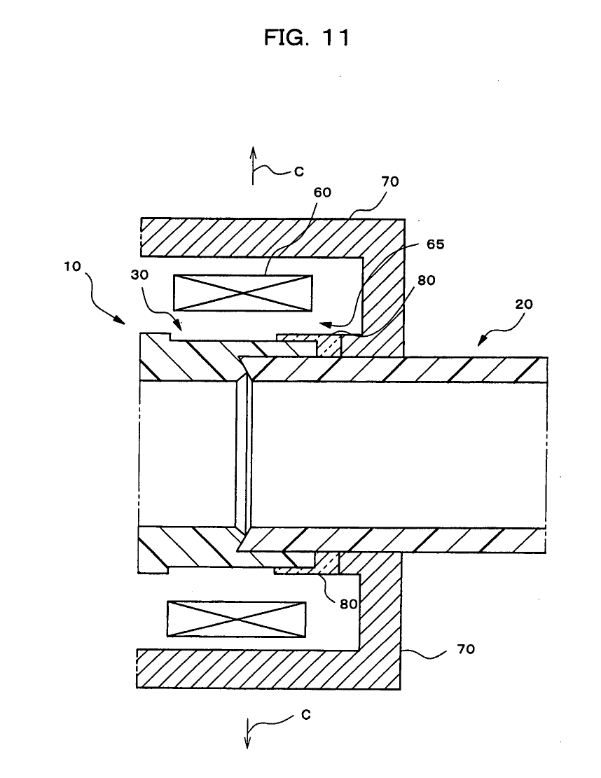

As shown in FIG. 11, a fixing member 80 which is divided into two segments may be built in the clamp 70. This fixing member 80 is provided such that it extends toward the inside from the portion where the clamp 70 holds down the plastic joint 10 and the plastic tube member 20. The fixing member 80 may be made of any material which will not be welded to the plastic joint 10 and the plastic tube member 20, such as glass, ceramic, or the like. Thereby, there is no need for previously mounting a fixing member 50 as described above to the end face of the plastic joint 10 at the mouth thereof.

According to the welding method for plastic joint pertaining to the present invention, the outer peripheral surface in the portion including at least the jointing faces in the junction part of the plastic joint and the plastic tube member is exposed, and the heat welding is carried out with the radiant heat from the heat source which is spaced apart from the junction part, whereby, in heating, the junction part is bulged also toward the side of the outer peripheral surface, which reduces the degree of bulge toward the side of the inner peripheral surface, and renders the bulge gentle, thus even if a bead is produced on the inner peripheral surface in the junction part of the plastic joint and the plastic tube which have been welded to each other, it can be made so small that it can have no ill effect such as causing a residence of the fluid, an increase in pressure loss of the fluid flow, or the like.

Further, the junction part is spaced apart from the heat source, thus the outer peripheral surface in the junction part can be rendered smooth and neat.

In addition, the junction part during welding can be visually observed without being hindered by the heat source, thus the degree of welding can be easily checked, and in case of PFA, the junction part is rendered more transparent when fused by heating, which allows the degree of welding to be checked more easily.

According to the junction part structure of the plastic joint pertaining to the present invention, also in case where the plastic joint is connected, rather than welded, to the plastic tube member, the finished product will provide the same effect as that which is provided by the plastic joint to which the plastic tube member has been welded using the above-described welding method for plastic joint.

What is claimed is:

1. A method of welding a plastic joint wherein a junction part is heated, said junction part including jointing faces of end faces of the plastic joint with heat weldability and a plastic tube member with heat weldability contacting with each other, comprising:
arranging the plastic joint and the plastic tube member such that an outer peripheral surface in a portion including at least the jointing faces in the junction part is exposed;
arranging a heat source at a location away from the junction part; and
heating and welding the junction part with radiant heat of the heat source.

2. The method of welding a plastic joint according to claim 1, wherein said part of the junction part is fixed with a fixing member such that the outer peripheral surface in the portion including at least the jointing faces in the junction part is exposed.

3. The method of welding a plastic joint according to claim 2, wherein said fixing member covers and fixes the portion of the junction part.

4. The welding method for plastic joint of claim 1, wherein said part of the junction part is fixed with a fixing member built in a clamp for fixing the plastic joint and the plastic tube member such that the outer peripheral surface in the portion including at least the jointing faces in the junction part is exposed.

5. A junction part structure of a plastic joint to be welded by heating a junction part, wherein said junction part includes jointing faces of end faces of the plastic joint with heat weldability and a plastic tube member with heat weldability contacting with each other, said junction part having gentle bulges on an outer peripheral surface and an inner peripheral surface.

6. The junction part structure of a plastic joint according to claim 5, wherein said bulges of the junction part have a degree of transparency higher than that of other portion.

7. The junction part structure of a plastic joint according to claim 5, wherein said plastic tube member is another plastic joint.
